(19) United States
(12) Patent Application Publication
(10) Pub. No.: US 2008/0159622 A1
(43) Pub. Date: Jul. 3, 2008

(54) Target object recognition in images and video

(75) Inventors: Naveen Agnihotri, Brooklyn, NY (US); Walter Borden, Bethesda, MD (US); David Schieffelin, Waterbury, CT (US)

Correspondence Address: VENABLE LLP, P.O. BOX 34385, WASHINGTON, DC, 20043-9998, US

(73) Assignee: The Nexus Holdings Group, LLC, Garden City, NY (US)

(21) Appl. No.: 12/000,153

(22) Filed: Dec. 10, 2007

Related U.S. Application Data
(60) Provisional application No. 60/873,573, filed on Dec. 8, 2006.

(51) Int. Cl. G06K 9/62

(52) U.S. Cl. 382/157; 382/156

(57) ABSTRACT

A computer-readable medium for performing target object recognition in images and video includes instructions for receiving target image data including a target object, applying non-negative matrix factorization with enforced sparseness to the target image data to generate target extracted image feature data, training a neural network to identify the target object using the target extracted image feature data to obtain a trained neural network, receiving object image data, applying non-negative matrix factorization with enforced sparseness to the object image data to generate object extracted image feature data, analyzing the object extracted image feature data with the trained neural network to obtain a result indicating whether the presence of the target object is identified in the object image data, and storing the result of analyzing the object extracted image feature data.

### CROSS-REFERENCE TO RELATED PATENT APPLICATION

This application is a Non-Provisional U.S. Application claiming the benefit of U.S. Provisional Patent Application No. 60/873,573, filed Dec. 8, 2006, by Borden et al, entitled “Real Time Automated Image and Object Recognition System and Process for Video and Still Image Feeds and Archives”, the contents of which are incorporated herein by reference in their entirety.

### BACKGROUND

Electronically stored data may be stored serially, for example, in the file directory structure of a computer system, or in an unstructured format, for example, on the Internet. These storage formats were created for their own separate purposes: to make it easy for the operating system to store and retrieve data (in the case of individual computer), and to facilitate the connectivity of large numbers of computers (for the, e.g., Internet). These methods of storing data may make it easier to answer questions about data storage history and geography, such as, for example, when was a file modified, or on which head/cylinder is a file located on disk; and may also make it easier to answer questions about data content, such as, for example, does a text file have a certain phrase in it somewhere or does an image file have a red pixel in it somewhere. Finding patterns embedded in such electronically stored data may be difficult, however, due to both the amount of data and the lack of appropriate structure to facilitate finding patterns in the data. For example, it may be much more difficult to answer descriptive questions about data, such as, for example, whether a file contains an image of a human face.

The human brain works in a different manner. People may find it harder to answer questions about history and geography, such as, for example, when did the US buy Alaska, or what the capital of Vermont is, but find it easier to answer questions about patterns, such as, for example, whether an image if of a human face. This may be because the human brain stores data in parallel, rather than serially, after breaking the data down into component parts (see, e.g., E. Wachsmuth et al., “Recognition of objects and their component parts: responses of single units in the temporal cortex of the macaque,” Cereb. Cortex, 4, 509-522, 1994, and S. E. Palmer, “Hierarchical structure in preceptual representations,” Cogn. Psychol. 9, 441-474, 1977). This may make it easier to find patterns either as a sum of their parts or holistically, and harder to answer questions that involve combining the parts in a nontraditional way. For example, most people cannot tell if an upside-down face is normal or distorted.

This conflict in data representation and access between people and computers may result in a gap between the way that people want to access data on computers and the access methods available on computers. For example, if a person is looking for a Frequently Asked Questions (FAQ) file that the person knows is stored somewhere on the person's computer, the person may find that it is easy to have the computer answer storage queries such as “find me all files in the directory ‘FAQ’”, more difficult to answer search queries such as “find me all files that have the word ‘FAQ’ in them”, and very difficult to answer pattern queries “find me all files that look like a FAQ file.” The difficulty the computer may have in answering the last question may be a result of the flat-file based data organization on the computer.

The unstructured data format of the Internet does not affect this difficulty in any qualitative way. Instead, the Internet increases the amount of data exponentially, so any solution may take longer to run or more computing power to run in the same amount of time.

There are currently several solutions for searching for patterns in electronically stored image data, which includes both video and still images stored in files. A first solution may tag image data with text data. The text data may contain descriptions of the image contents as well as descriptions pertaining to the image contents, such as related phrases. This method requires that image data be tagged before being searched. Tagging may be time-consuming, labor intensive, and of dubious accuracy. A second solution may use neural networks to perform pattern recognition in image data. A neural network may be trained using image data representative of the data being searched for, and may then be used to search through image data. The ability of a neural network to perform accurate searches may be highly dependent on the quality of the training data, and the neural network may function as a “black box,” making correcting or fine-tuning the operation of a neural network difficult.

In the first previously used solution for searching image data, image data may be tagged with text data indicating its content. This first solution may be the one in use by popular Internet search engines, such as, for example, Google and Yahoo, to conduct image searches. File formats for storing image data may allow adding tags containing text data, which may be referred to as meta-tags, to the image. When searching through image data contained in files that have been tagged, the search engine may treat each file of image data as if it were just the text from its meta-tag, and perform searches on that text.

This first solution relies on human users to add the meta-tags to the image data. Users may not know how to add meta-tags or may add intentionally or unintentionally false or misleading meta-tags. Adding meta-tags to image data takes time and effort on the part of users. As the amount of image data available to be tagged increases, it may become infeasible to have users tag every piece of available image data.

In the second previously used solution for searching through image data, the content of the file containing the image data may be examined, for example, using neural networks. An artificial neural network (hereafter referred to as a “neural network”) may be composed of an interconnected group of artificial neurons, represented on a computer, for example, as an array data structure. Each artificial neuron may be modeled after actual biological neurons in the brain. Neural networks may be designed to capture some properties of biological networks by virtue of their similarity in structure and function. The individual artificial neurons may be simple, but the neural network may be capable of complex global behavior, determined by the properties of the connections between the neurons (see, e.g., C. M. Bishop, Neural Networks for Pattern Recognition, Oxford University Press, 1996).

A neural network may be trained to differentiate one kind of pattern from another using the proper setup parameters for the neural network and a large training data set. A neural network may extract numerical characteristics from numerical data instead of memorizing the data. A neural network used for searching through image data may first be trained with a data set containing some image data of the particular image feature being searched and some image data that does not contain the particular featuer. For example, if image data is being searched for the face of the actor Kurt Douglas, the neural network may be trained using image data including video files and still image files, some of which contain Kurt Douglas's face and some of which do not. During training, the image data from the training data set is input into the neural network, which may attempt to determine whether or not the image data in the training set contains the feature being searched for, i.e., Kurt Douglas's face. For each separate video and still image file, the neural network may produce a yes or no answer, and whether or not the neural network's answer is correct may be input to the neural network. A learning algorithm, such as, for example, a back propagation algorithm, may be used to adjust the neural network based on whether or not the neural network's answers to the input training data are correct.

After sufficient training, a large set of image data may be input into the neural network, which may then attempt to find the searched-for feature in each file in the larger set of image data, and produce results identifying the files in the large image data set containing the searched-for feature. For example, all of the video and still image files stored on a computer hard drive may be input into a neural network that has been trained to search for Kurt Douglas's face. The neural network may identify each video and still image file on the hard drive that contains Kurt Douglas's face.

This second solution requires that the neural networks in use be trained upfront. Whereas many software-based search solutions work without requiring training, a neural network may need to be trained, and without such training a neural network may not be capable of performing useful pattern matching. With the appropriate training, a neural network may be able to outperform virtually all non-pattern-oriented algorithmic approaches.

Neural networks may also require little or no a priori knowledge of the problem the neural network is implemented to solve. For example, if a neural network is to be used to search for Kurt Douglas' face, this does not need to be factored in to the programming of the neural network. This may allow a neural network to solve hard problems, even mathematically intractable and computationally hard problems. However, this may also make it harder to adjust and fine tune the operation of a neural network, as there may be no way to specify in the programming of the neural network any previously known facts about the relationships between the input or inputs and the output. The functionality and usefulness of a neural network may be entirely dependent on the training data set. A neural network may build relationships from inputs to outputs, but the functioning of the neural network may be considered to be a “black box.”

One system using neural networks for pattern recognition is described in U.S. Pat. No. 7,127,087, issued to Fu Jie Huang on Nov. 28, 2006. A pose-invariant face recognition system is constructed from neural networks. Preprocessed images of faces are used to train a set of neural networks made up of a plurality of first stage neural networks. The images of faces are preprocessed by being normalized, cropped, categorized, and abstracted. Abstraction may be done by histograming, Hausdorff distance, geometric hashing, active blobs, or the use of eigenface representations and the creation of PCA coefficient vectors to represent each normalized and cropped face image. Each of the first stage neural networks may be dedicated to a particular pose range. A second stage neural network is used to combine or fuse the outputs from each of the first stage neural networks. This process uses eigenvalues and eigenvectors. The method described in Huang is used only for facial recognition, as it is directed to recognizing a person's face from a facial image regardless of the position of a person's head when the facial image is created. The abstraction techniques employed in Huang are all well known in the art.

A third solution for pattern matching in image data, especially video, utilizes Bayesian belief networks, as described in U.S. Published Patent Application No. 2006/0201157 A1 which published Sep. 21, 2006. A Bayesian Belief Network pattern recognition engine is used to perform a “face present” analysis on the image data of a music video as part of a content analysis of the music video. While this system may be useful for music video indexing and summarization, it does not serve to identify a particular feature from the image data of the music video.

A fourth solution for pattern matching in image data, especially video, may be summarization of video content through analysis of data other than video data, such as is described in A. Hauptmann and M. Smith, “Text, Speech, and Vision for Video Segmentation: The Informedia Project,” American Association for Artificial Intelligence (AAAI), Fall, 1995, Symposium on Computational Models for Integrating Language and Vision (1995), the “InforMedia Project.” Speech recognition applied to audio data in the video, and natural language understanding and the reading of caption text may be used to summarize video content and provide short synopses of the video. This method may not be able to locate particular image features, such as, for example, a specific face, within a video or other image data, as the method does not examine the image data itself. Instead, the video is summarized based on its audio and textual content, and can therefore only be searched based on that audio and textual content.

### SUMMARY

One embodiment includes a computer-readable medium comprising instructions, which when executed by a computer system causes the computer system to perform operations target object recognition in images and video, the computer-readable medium including: instructions for receiving an item of target image data, wherein the item of target image data includes a target object, instructions for applying non-negative matrix factorization with enforced sparseness to the item of target image data to generate an item of target extracted image feature data, instructions for training a neural network to identify the target object using the item of target extracted image feature data to obtain a trained neural network, instructions for receiving an item of object image data, instructions for applying non-negative matrix factorization with enforced sparseness to the item of object image data to generate an item of object extracted image feature data, instructions for analyzing the item of object extracted image feature data with the trained neural network to obtain a result indicating whether the presence of the target object is identified in the item of object image data, and instructions for storing the result of analyzing the item of object extracted image feature data.

One embodiment include a computer-implemented method for target object recognition in images and video including: receiving an item of target extracted image feature data generated by applying non-negative matrix factorization with enforced sparseness to an item of object image data, wherein the item of target extracted image feature data includes a target object, training a neural network to identify the target object using the item of target extracted image feature data to obtain a trained neural network, receiving an item of object extracted image feature data generated by applying non-negative matrix factorization with enforced sparseness to an item of object image data, analyzing the item of object extracted image feature data with the trained neural network to obtain a result indicating whether the presence of the target object is identified in the item of object image data, and storing the result of analyzing the item of object extracted image feature data.

One embodiment includes an apparatus for target object recognition in images and video including: means for receiving an item of target image data, wherein the item of target image data includes a target object, means for applying non-negative matrix factorization with enforced sparseness to the item of target image data to generate an item of target extracted image feature data, means for training a neural network to identify the target object using the target extracted image feature data to obtain a trained neural network, means for receiving an item of object extracted image feature data generated by means for applying non-negative matrix factorization with enforced sparseness to an item of object image data, means for analyzing the item of object extracted image feature data with the trained neural network to obtain a result indicating whether the presence of the target object is identified in the item of object image data, and means for storing the result of analyzing the item of object extracted image feature data.

One embodiment includes a system for target object recognition in images and video including: a neural network module adapted to receive target extracted image feature data generated by applying non-negative matrix factorization with enforced sparseness to target image data including target extracted image feature data for a target object, be trained to identify the target object with the target extracted image feature data, receive object extracted image feature data generated by applying non-negative matrix factorization with enforced sparseness to object image data, analyze the object extracted image feature data to obtain a result indicating whether the presence of the target object is identified in the object image data, and store the result of analyzing the object extracted image feature data for the presence of the target object in the object image data.

### BRIEF DESCRIPTION OF THE DRAWING FIGURES

The present disclosure will be more thoroughly explored with reference to the accompanying drawings.

FIG. 1 depicts an exemplary system diagram for target object recognition in images and video.

FIG. 2 depicts an exemplary flowchart for target object recognition in images and video.

FIG. 3 depicts an exemplary screenshot of extracted image feature files.

FIGS. 4A-4K depict exemplary screenshots for a system for an automated image and object recognition system.

FIG. 5 depicts an exemplary architecture for implementing a computing device for use with the various embodiments.

### DEFINITIONS

In describing the invention, the following definitions are applicable throughout (including above).

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, or a chip set; a system-on-chip (SoC) or a multiprocessor system-on-chip (MPSoC); and an apparatus that may accept data, may process data in accordance with one or more stored software programs, may generate results, and typically may include input, output, storage, arithmetic, logic, and control units.

“Software” may refer to prescribed rules to operate a computer or a portion of a computer. Examples of software may include: code segments; instructions; applets; pre-compiled code; compiled code; interpreted code; computer programs; and programmed logic.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a memory chip; and/or other types of media that can store data, software, and other machine-readable instructions thereon.

A “computer system” may refer to a system having one or more computers, where each computer may include a computer-readable medium embodying software to operate the computer. Examples of a computer system may include: a distributed computer system for processing information via computer systems linked by a network; two or more computer systems connected together via a network for transmitting and/or receiving information between the computer systems; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables and/or temporary connections such as those that may be made through telephone or other communication links. A network may further include hard-wired connections and/or wireless connections. Examples of a network may include: an internet, such as the Internet; an intranet; a local area network (LAN); a wide area network (WAN); and a combination of networks, such as an internet and an intranet. Exemplary networks may operate with any of a number of protocols, such as Internet protocol (IP), asynchronous transfer mode (ATM), and/or synchronous optical network (SONET), user datagram protocol (UDP), IEEE 802.x, etc.

### DETAILED DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

Embodiments relate to image analysis of various objects including human faces as well as inanimate objects, whether in real time or archived form, and are applicable to video or plural image feed, through neural network(s) using a parts-based representation of the target objects to analyze and search patterns in the image feed, without necessarily being reliant on data tags, meta tags, biomedics, indexing or human review intervention in advance.

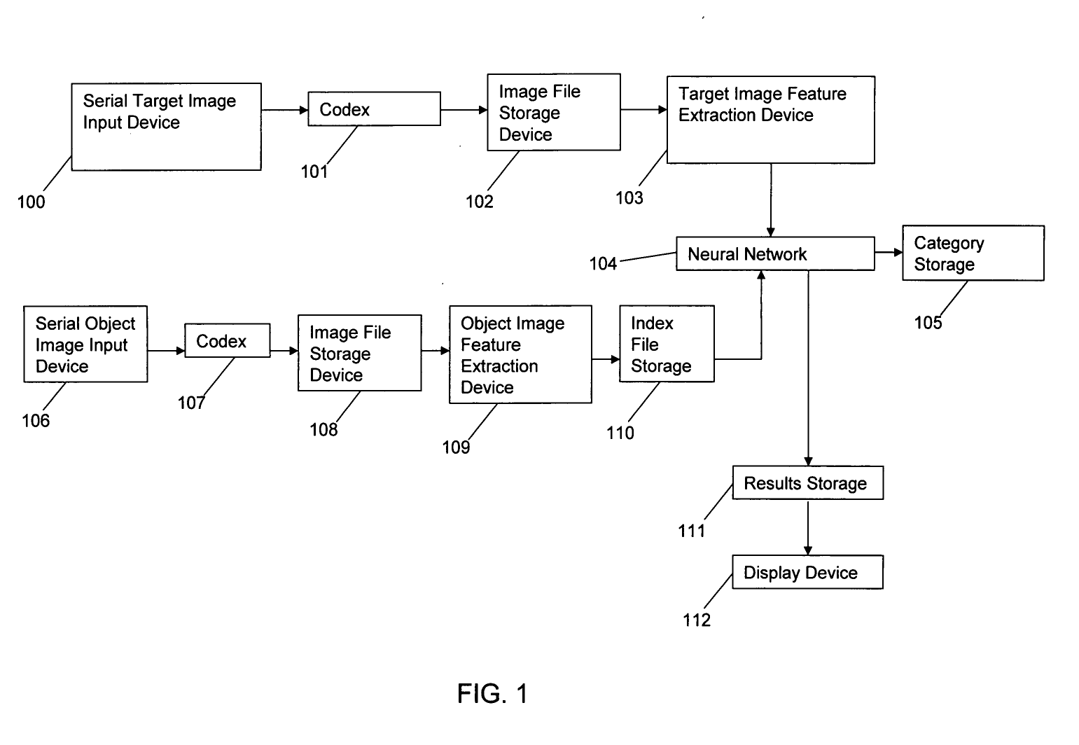

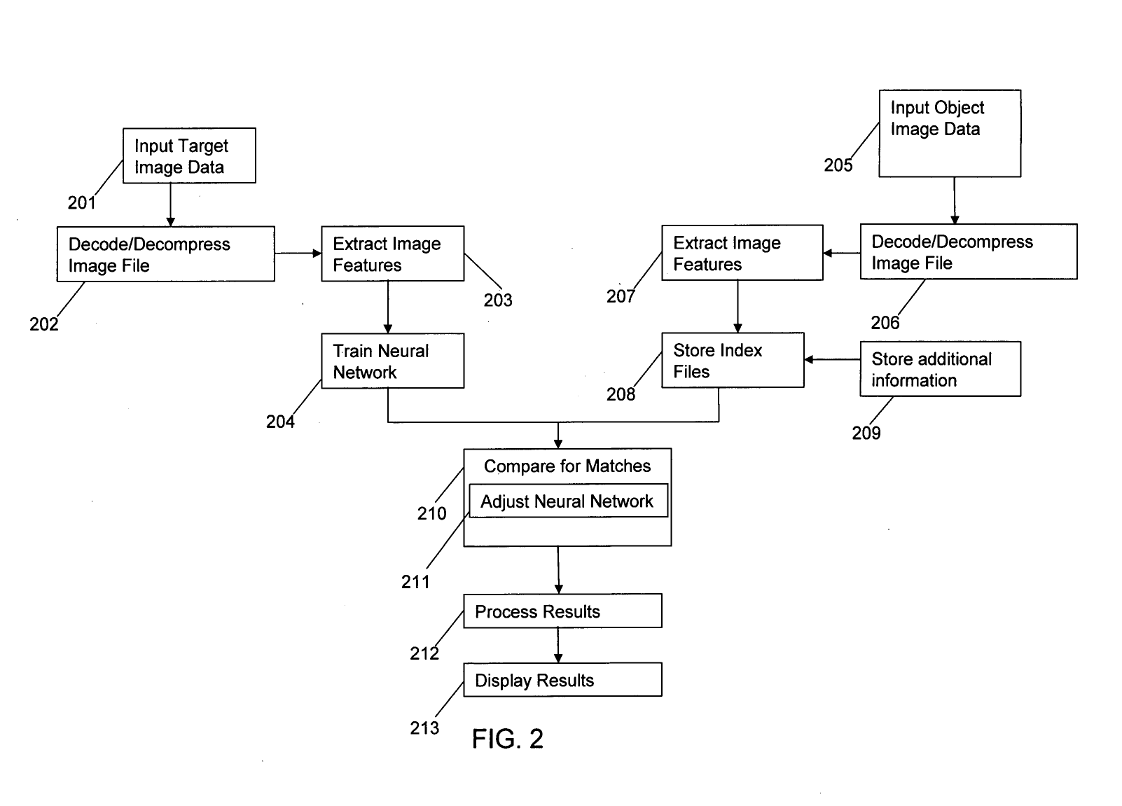

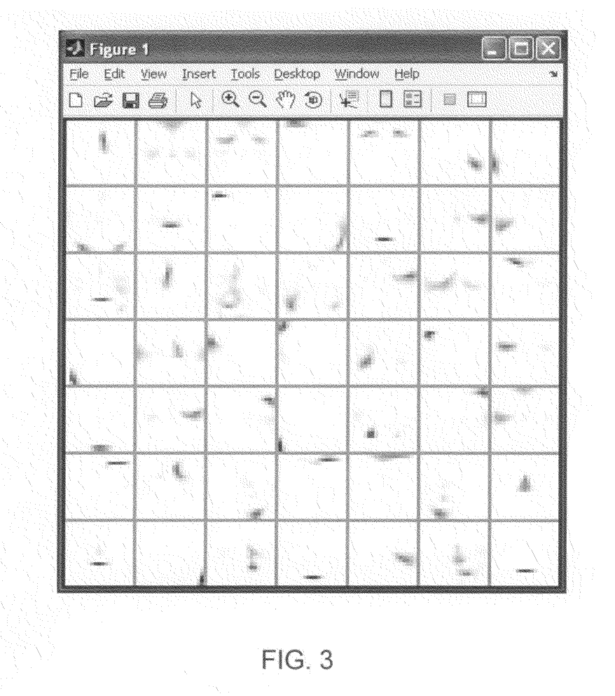

FIG. 1 depicts an exemplary system diagram for target object recognition in images and video. Image data, including items of image data containing a target object, may be received by a serial target image input device 100. This image data may be target image data. Each item of image data may embodied as a video file or image file, and may be tagged or labeled with or otherwise linked to identification information indicating whether or not the image or video file contains the target object. For example, a user may upload to a website image files in the Joint Photographics Expert Group (JPEG) image format and video files in the Motion Pictures Expert Group (MPEG) format, some of which contain the target object selected by the user, for example, Kurt Douglas's face.

The target image data may be transferred to a codex 101, where the image data may be decoded or decompressed to create target image files. The target image files may contain images or video. For example, the JPEG image files uploaded to the website may be decompressed into bitmapped (BMP) files by the codex 101. The identification information for each item of target image data may be preserved in the target image files.

The target image files may be stored on target image file storage device 102. The target image files may then be transferred from the target image file storage device 102 to target image feature extraction device 103. The target image feature extraction device 103 may apply non-negative matrix factorization (NMF) with enforced sparseness to the target image files to produce target extracted image feature data, which may be in the form of target extracted image feature files. NMF is discussed further below with reference to block 203. If a target image file contains video, frames of the video may be selected to be converted to target extracted image feature files. The target extracted image feature files may be sparse representations of the target image data. The identification information for each item of target image data may be persevered in the target extracted image feature files. For example, the BMP files created from the JPEG files uploaded by the user may have NMF with enforced sparseness applied to them, generating target extracted image feature files that may be sparse representations of the image contained in the JPEG files uploaded by the user.

The target extracted image feature files may be used to train neural network 104 to identify the target object. The target extracted image feature files and the identification information for each file may be used as a training data set for the neural network 104, as is known in the field of artificial intelligence. For example, the target extracted image feature files created from the BMP files, in turn created from the user uploaded JPEG files, may be used to train the neural network 104 to identify Kurt Douglas's face.

Concurrently and/or sequentially with the above, image data may be received by a serial object image input device 106. This image data may be object image data. The object image data may be the image data which will be searched for the presence of the target object. For example, a user may a select an online archive of movies and movie stills through which the user wishes to search for movies or movie stills containing Kurt Douglas's face.

The object image data may be transferred to a codex 107, which may operate in the same manner as the codex 101 to create object image files. The object image files may contain images or video, and each object image file may be linked to the item of object image data from which the object image file was created. For example, the movies and movie stills in the online archive may be transferred to the codex 107 and decompressed and/or decoded from whatever file format may have been used to encode or compress the movies and movie stills. An object image file created from a movie still may contain a link back to that movie still in the online archive.

The object image files may be stored on object image file storage device 108. The object image files may then be transferred from the file storage device 108 to object image feature extraction device 109. The object image feature extraction device 109 may operate in the same manner as the target image feature extraction device 103, to produce object extracted image feature data, which may be in the form of object extracted image feature files. If an object image file contains video, frames of the video may be selected to be converted object extracted image feature files. The object extracted image feature files may be sparse representations of the object image data. The link back to the item of object image data may be preserved. For example, object image files created from the movies and movie stills from the online archive may be converted into object extracted image feature files. The object extracted image feature file created from an object image file created from a movie still may contain a link back to that movie still in the online archive.

The object extracted image feature files may be stored in an index file in the index file storage 110. The index file may be used immediately, and also may be retrieved at a later time. For example, if the movies and movie stills came from the online archive of Universal Pictures movies from between 1950 and 1960, the object extracted image features files may be stored in an index file labeled “Universal Pictures movies, 1950-1960.” If, at a later time, a user wants to search for a target object in the online archive of Universal Pictures movies from between 1950 and 1960, the index file for that archive may be retrieved from the index file storage 110.

The object extracted image feature files may then be input to the neural network 104, which may determine whether or not the target object is present in any of the object extracted image features files, and therefore present in the image data linked to the objected extracted image feature files. For example, the object extracted image feature files from the “Universal Pictures movies, 1950-1960” index file may be input to the neural network 104 after the neural network 104 has been trained to identify the presence of Kurt Douglas's face. The neural network 104 may then identify whether or not Kurt Douglas's face is present in any of the image data from the online archive by analyzing the object extracted image feature files. The neural network 104 may produce results listing links back to the items of image data in the online archive in which Kurt Douglas's face is present, or in which the probability that Kurt Douglas's is present exceeds some threshold, user selected or otherwise determined.

The serial target image input device 100 may be any computer, computer system, or component thereof capable of receiving image data. The serial target image input device 100 may be implemented as any suitable combination of hardware and software for receiving image data and transferring the image data to a codex or storage device. Image data received by the serial target image input device 100 may be the image data containing the image features being searched for, i.e. the target object.

The codex 101 may be any computer, computer system, or component thereof capable of decoding at least one image and/or video file format. The codex 101 may be implemented as any suitable combination of hardware and software. Image data in a compressed and/or encoded image and/or video file format input into the codex 101 may be output in an uncompressed and/or unencoded file format. For example, a still image file compressed using a Joint Photographics Experts Group (JPEG) compression may be decompressed by the codex 101 and output as a bitmap file or in a raw file format. The codex 101 may not be used if uncompressed and unencoded files are received by the serial target image device 100. The codex 101 may also not be used at the option of a system designer.

The target image file storage device 102 may be any computer, computer system, or component thereof suitable for storing image data, such as, for example, the image data output by the codexes 101. The target image file storage device 102 may utilize a temporary computer-readable medium, such as, for example, random access memory, or a permanent computer-readable medium, such as, for example, a magnetic hard disk. The target image file storage device 102 may be implemented using a single or plurality of hardware devices, and may employ software or hardware suitable for managing the storage and retrieval of image. Image data may be stored on the target image file storage device 102 organized within file folders, as a stream of image value data, or in any other suitable format.

The target image feature extraction device 103 may be any computer, computer system, or component thereof capable of extracting key features from image data to generate target extract image feature data, which may be stored as, for example target extracted image feature files. The target image feature extraction device 103 may be implemented as any suitable combination of hardware and software. Image data, in the form of video and/or still image files in encoded, compressed, or unencoded and/or uncompressed formats, may be input into the target image feature extraction device 103. Extraction of features from the input image data may be performed by the application of non-negative matrix factorization (NMF) with enforced sparseness to the image data. The target image feature extraction device 103 may store the results of the extraction performed on the image data, the target extracted image feature file, in a temporary or permanent computer-readable medium.

The neural network 104 may be any suitable combination of hardware and software used to implement the artificial intelligence construct of a neural network. For example, the neural network 104 may be a series of data structures, such as, for example, arrays, created by a software program, and a series of instructions for using the arrays for neural network processing, running on a computer or computer system. The neural network 104 may receive input data and produce output data based on the input data. The output data produced by neural network 104 may be dependent on the structure of the neural network 104, and may be, for example, a yes or no, a numerical value, or any other data that may be output from a computer or computer system. The neural network 104 may include an input layer with any suitable number of nodes, an output layer with any suitable number of nodes, and any suitable number of hidden layers each with any suitable number of nodes, with any suitable number of weights connecting the nodes in separate layers. The nodes may be additive, multiplicative, or employ any other function suitable for nodes in neural networks. For example, if applying NMF with enforced sparseness to the target image data produces a 10×6 matrix and 6×20 matrix, 6 may be the rank of the factorization, and the neural network 104 may include an input layer of 6 nodes, two hidden layers of 6 or fewer nodes each, and one output layer of 6 nodes, where each node may be additive and each layer may be fully connected to the above and below layers, i.e., the input layer fully connected to the first hidden layer, the first hidden layer fully connect to the second hidden layer, and the second hidden layer fully connected to the output layer. The neural network 104 may be capable of being trained through the use of a training data set in combination with a learning algorithm such as, for example, a back propagation algorithm. Once the neural network 104 has been trained, it may perform pattern matching based on the data contained in the training data set used in the training.

Category storage 105 may any suitable combination of hardware and software that may be used to store and retrieve data for the neural network 104. For example, the category storage 105 may be a permanent computer-readable medium, such as a hard drive, working in conjunction with software for the management of neural network data, such as, for example, the number of layers, the number of nodes in each layer, and the weights between nodes and the values of said weights. The category storage 104 may store the data describing the makeup of the neural network 104, such, as for example, the weighting values for each of the connections between nodes in the neural network 104. The data may be retrieved from the category storage 105 at a later time to reconstitute the trained neural network 104. A description of what the training data set that resulted in the weighting values from the neural network 104 may be stored with the weighting values in the category storage 105. For example, if the neural network 104 was trained to identify Kurt Douglas's face, the weighting values from the neural network 104 may be stored in category storage 105 with the description “Kurt Douglas' face.” If, at a later time, a search of image data for Kurt Douglas's face is performed, the weighting values for “Kurt Douglas' face” may be retrieved from category storage 105 and used in the neural network 104 to perform the search without having to train the neural network 104.

The serial object image input device 106 may be any computer, computer system, or component thereof capable of receiving image data. The serial object image input device 106 may be implemented as any suitable combination of hardware and software for receiving image data and transferring the image data to the codex 107 or the object image file storage device 108. Image data received by the serial object image input device 106 may be the image data to be searched through to locate matches for the target image. In one embodiment, the serial object image input device 106 may be the same device as the serial target image input device 100.

The codex 107 may be any computer, computer system, or component thereof capable of decoding at least one image and/or video file format. The codex 107 may be implemented as any suitable combination of hardware and software. Image data in a compressed and/or encoded image and/or video file format input into the codex 107 may be output in an uncompressed and/or unencoded file format. For example, a still image file compressed using a JPEG compression may be decompressed by the codex 107 and output as a bitmap file or in a raw file format. The codex 107 may not be needed if uncompressed and unencoded files are received by the serial object image input device 106. The codex 107 may also not be used at the option of a system designer. In one embodiment, the codex 101 may be the same device as the codex 107.

The object image file storage device 108 may be any computer, computer system, or component thereof suitable for storing image data, such as, for example, the image data output by the codex 107. The image file storage device 107 may utilize a temporary computer-readable medium, such as, for example, random access memory, or a permanent computer-readable medium, such as, for example, a magnetic hard disk. The object image file storage device 108 may be implemented using a single or plurality of hardware devices, and may employ software or hardware suitable for managing the storage and retrieval of image. Image data may be stored on the object image file storage device 108 organized within file folders, as a stream of image value data, or in any other suitable format. In one embodiment, the target image file storage device 102 may be the same device as the object image file storage device 108.

The object image feature extraction device 109 may be any computer, computer system, or component thereof capable of extracting key features from image data to generate object extracted image feature data, which may be stored as, for example, object extracted image feature files. The object image feature extraction device 109 may be implemented as any suitable combination of hardware and software. Image data, in the form of video and/or still image files in encoded, compressed, or unencoded and/or uncompressed formats, may be input into the object image feature extraction device 109. Extraction of features from the input image data may be performed by, for example, the application of non-negative matrix factorization (NMF) with enforced sparseness to the image data. The object image feature extraction device 109 may store the results of the extraction performed on the image data in a temporary or permanent computer-readable medium. In one embodiment, the object image feature extraction device 109 may be the same device as the target image feature extraction device 103.

The index file storage 110 may be any combination of hardware and software capable of storing the output of the object image feature extraction device 109. For example, the index file storage 110 may be a permanent computer-readable medium, such as a hard drive, working in conjunction with file management software. When the object image feature extraction device 109 process an item of image data, for example, a single still image file, the extracted image features may be stored in a file smaller than original item of image data. The file containing extracted image features may be stored in the index file storage 110 as an index file meta file, or as any other data structure suitable for linking the extracted image features back to the original item of image data from which the image features were extracted.

Results storage 111 may be any combination of hardware and software capable of storing the results of searching the image data. For example, the results storage 110 may be a permanent computer-readable medium, such as a hard drive, working in conjunction with file management software. The neural network 104 may produce output indicating, either by a yes or no answer, a probabilistic answer, or other means, whether the target object is present in a searched item of image data. The results storage 104 may store these results produced by the neural network 104 by, for example, storing the items of image data in which the presence of the target object has been identified, or identified to within a certain probability; storing the extracted image feature files from the image data identified as containing, or containing to with a certain probability, the target object, along with a link to the original item of image data; storing each item of image data (or extracted image feature file) searched along with the results for each item of image data; storing the results for each item of image data searched along with a link back to the original item of image data; or any other combination of image data, extracted image features and results that allow for the retrieval of the results of the searching of the image data.

Display device 112 may be any hardware display device with access to the results storage 111. For example, the display device 112 may be a computer monitor connected to a computer system on which the results storage 111 resides. The display device 112 may be capable of presenting image data from the results storage 111, for example, to a user.

The separate components depicted in FIG. 1 may be part of a single computer or computer system. Alternatively, the components may be on any number of connected computers or computer systems connected via any suitable connection method, such as, for example, local area network (LAN), a wide area network (WAN) or the Internet.

FIG. 2 depicts an exemplary flowchart for target object recognition in images and video, and will be discussed below with reference to FIG. 1.

In block 201, target image data may be received by, for example, the serial target image input device 100. The target image data may be received from any suitable source, such as, for example, any computer-readable medium or any image data generating hardware, such as, for example, a camera or scanner, accessible to the serial target image input device 100 through any suitable connection. For example, the image data may be uploaded by a user to the serial target image input device 100 through the Internet. The image data may be in the form of a video file or a still image file, may be in any video or still image file format, and may be found in any suitable manner, such as, for example, a manual search of files, through a network automated search engine, or through use of a web crawler or other such Internet searching robot. The target image data may be selected so that at least some of the items of image data contain the target object. The target object may be any image feature. For example, the target object may be the face of a specific person or the faces of people who wear glasses; an inanimate object of any type, such as, for example, cars in general, or a particular type of car; a particular type of scene, such as, for example, images or videos featuring people playing baseball; etc.

Each item of target image data may or may not contain the target object, as both types of target images are useful in neural network training. For example, if the target object is Kurt Douglas's face, some of the target image data may not contain Kurt Douglas's face. Each item of target image data may be tagged or otherwise linked to identification information indicating whether or not the item of image data contains the target object. Within block 201, the serial target image input device 100 may receive one, or more than one, items of target image data. The number of items of image data received by the serial target image input device 100 before flow proceeds to block 202 may depend on design preference and the constraints of the system, such as, for example, the amount of both permanent and temporary memory available to the separate components of the system. For example, if the serial target image input device 100 has access to only a small amount of temporary memory, the serial target image device 100 may receive only one item of image data at a time.

In block 202, the target image data may be decoded and/or decompressed by, for example, the codex 110. The codex 101 may receive the target image data from the serial target image input device 100. The codex 101 may decode and/or decompress the image data, resulting in the creation of a target image file for each item of target image data input into the codex 101. The target image file may be a decompressed and/or unencoded file, and may be in the form of pixel values capable of display. For example, if a still image file in JPEG format is input into codex 101, the codex 101 may decode the JPEG and output a target image file in BMP or raw format. The image data or target image file may be cropped, sized, normalized, weighted or otherwise manipulated before or after being processed by the codex 101, which may reduce the amount of data being processed. Each target image created by the codex 101 may be transferred to the target image file storage device 102 to be stored. Block 202 may be run after all of the image data received in block 201 has passed through the codex 101, or may only be run after some lesser amount of the image data has passed through the codex 101, depending on the constraints of the system and design preference. For example, in one embodiment, only one item of image data may pass through the codex 101 before flow proceeds to block 203. Flow may also proceed back to block 201, again depending on design preference.

In block 203, the target image files may undergo image feature extraction performed by, for example, the target image feature extraction device 103. The target image files created by the codex 101 may be transferred from the target image file storage device 102 to the target image feature extraction device 103. The target image feature extraction device 103 may perform the process of image feature extraction using non-negative matrix factorization (NMF) with enforced sparseness on a target image file to create a target extracted image feature file. Applying NMF with enforced sparseness to the target image file may extract various features from the target image file on a predetermined basis. For example, if the target object in the target image file is a person's face, various key aspects of the person's face, such as, for example, the eyes, nose, mouth, etc., may be extracted from the target image file into the target extracted image feature file.

When processing a target image file that is video or slideshow, the target image feature extraction device 103 may process each frame of the video or each image in the slideshow, or may selectively sample the frames of the video or slideshow to reduce processing requirements. For example, if the target image is a video, every fifth frame, for example, may be sampled. Alternatively, rather than sampling on a periodic basis at a given frequency or randomly, the sampling of the video may occur based on the video's contents. For example each frame of a video or slideshow may have metadata or other data connected. If metadata is connected, or pre-processing has identified various characteristics of the frames, such as, for example, the presence of a given skin tone that may be of a Caucasian's color temperature, or virtually any data that might preexist in association with the image, then the frames that are likely to be data rich for the target object may be selected intelligently, rather than through a random or periodic selection of individual still images or frames.

The target extracted image feature files may contain links back to the original item of image data, for example, the still image or frame of a video, from which it was created. The target extracted image feature files may also include information regarding the quality, data, time or other text, and other attributes or any searchable data, etc. that may be associated with item of image data from which they were created.

To perform NMF with enforced sparseness on an image file, such as a target image file, the image file may be analyzed as part of a n×m data set V. Each one of the m columns may contain n non-negative values of data, wherein each of the m columns represents an image file, and each of the n rows in a given column m represents a value for a pixel of the image file represented by the column m. An approximate factorization of the form V≈WH, or

$${V}_{i μ} \approx {( WH )}_{i μ} = {\sum }_{a = 1}^{r} {W}_{ia} {H}_{a μ}$$

may be constructed.

The r columns of W may be the bases, and each column of H may be an encoding and may be in one-to-one correspondence with a data column in V. An encoding may include the coefficients by which a data column is represented with a linear combination of bases. The dimensions of the matrix factors W and H may be n×r and r×m, respectively. The rank r of the factorization may be chosen so (n+m)r<nm, and the product WH may be regarded as a compressed form of the data in V.

Non-negative matrix factorization does not allow negative entries in the matrices W and H. Only additive combinations may be allowed, because the non-zero elements of W and H may all be positive. The non-negativity constraints may be compatible with the intuitive notion of combining parts to form a whole.

Applying NMF to data may produce a sparse representation of the data. A sparse representation may encode much of the data using few ‘active’ components, which may make the encoding easy to interpret. However, the sparseness produced by NMF may be a side-effect of the process. The sparseness of the representation may not be controllable using conventional NMF techniques. The following methods may be used to enforce and control the sparseness of the factorized matrices produced through the application of NMF.

To find an approximate factorization V≈WH, first a cost function may be defined that defines the quality of the approximation. The most straightforward cost function may be the square of the Euclidian distance between the two terms:

$${‖ V - WH ‖}^{2} = {\sum }_{ij} {( {V}_{ij} - {( WH )}_{ij} )}^{2}$$

The divergence between the two terms may be defined as:

$$D ( V ‖ WH ) = {\sum }_{ij} ( {V}_{ij} log \frac{{V}_{ij}}{{( WH )}_{ij}} - {V}_{ij} + {( WH )}_{ij} )$$

Like the Euclidian distance, these terms may also have a lower bound of zero, and vanish if and only if V=WH. ∥V−WH∥² may then be minimized with respect to W and H, subject to the constraint that W, H≧0.

The following multiplicative algorithm may be used to factorize V:

$${W}_{ia} ← {W}_{ia} {\sum }_{μ} \frac{{V}_{i μ}}{{( WH )}_{i μ}} {H}_{a μ}$$

$${W}_{ia} ← \frac{{W}_{ia}}{{\sum }_{j} {W}_{ja}}$$

$${H}_{a μ} ← {H}_{a μ} {\sum }_{j} {W}_{ia} \frac{{V}_{i μ}}{( WH ) i μ}$$

For measuring sparseness, a measure based on the relationship between the L1 and L2 norms may be used:

$$sparseness ( x ) = \frac{\sqrt{n} - ( \sum \vert {x}_{i} \vert ) / \sqrt{\sum {x}_{i}^{2}}}{\sqrt{n} - 1}$$

where n is the dimensionality of x.

To adapt the NMF algorithm for enforced sparseness, sparseness may be constrained at the end of every iteration in the following way:

sparseness(wᵢ)=S_{w},∀i

sparseness(hᵢ)=Sₕ,‡i

where wᵢ is the i th column of W and hᵢ is the i th column of H. S_{w} and Sₕ may be the desired sparseness of W and H respectively, and may be set at the beginning.

Applying NMF with enforced sparseness to the target image file in this manner may result in the target extracted image feature file, which may be a sparse representation of the target image file. The target extracted image feature file may be stored as a separate file, and may be sized, cropped, normalized, weighted, or otherwise manipulated as necessary.

FIG. 3 depicts an exemplary screenshot of extracted image feature files. Forty-nine image files may be used to form a data-set V, and NMF with enforced sparseness may be applied to V as described above. Each box of the grid may represent the extracted image feature files resulting from NMF with enforced sparseness being applied to V. Various images of one person, for example, may have features extracted using NMF with enforced sparseness. The images may be reduced to images of such features as eyebrows, eyes, nose, mouth, etc. For example, the box in row 1, column 5 may depict a pair of eyes as a result of the application of NMF with enforced sparseness to an image.

Block 203 may run until all of the target image files received from the codex 101 have been processed with NMF, or may only run until some lesser number of the target image files have been processed with NMF, depending on the constraints of the system and designer preference. Flow may also proceed back to block 201 or 202, again depending on designer preference.

In block 204, the target extracted image feature files may used to train a neural network, for example, the neural network 104. The target extracted image feature files may be input to the neural network 104 along with the identification information indicating whether or not a target extracted image feature file contains the target object, as the training data set used to train the neural network 104. Training of the neural network 104 may take place in any suitable manner from the field of artificial intelligence. The neural network 104 may attempt to determine whether or not the target object is in the target extracted image feature file. The answer given by the neural network 104 may be checked against the identification information, and whether or not the neural network 104 produced the correct answer, and the discrepancy between the correct answer and the neural network 104's answer, may be used as part of learning algorithm to adjust the weightings of the connections between nodes in the neural network 104. As a result of these adjustments, the neural network 104 may become more accurate in determining whether or not an extracted image feature file input into the neural network 104 contains the target object.

Block 204 may be repeated with additional target extracted image feature files, either by looping through block 204 if more target extracted image feature files area available, or looping back through any of the previous blocks, resulting in more target extracted image feature files becoming available. In either case, block 204 may be looped through until there are no more target extracted image feature files to be input to the neural network 104 and no more image data or image files are made available to be turned into target extracted image feature files, or until the neural network 104 has achieved some desired level of accuracy in its answers. The desired level of accuracy to be achieved may be set by, for example, a default setting in the neural network 104, selection by a user, or by any other suitable means, and may be any level of accuracy.

The results of the neural network training in block 204 may be stored in category storage 105, for example, in the form of the node structure and weighting values between the nodes for the neural network 104. This data from the neural network 104 may be used to configure the neural network at a later time to perform a search for the target object, instead of repeating blocks 201-204. For example, if category storage 105 contains data from a neural network previously trained to identify the target object of Kurt Douglas's face, that data may be used to configure the neural network 104 when a future search is performed for Kurt Douglas's face, precluding the need to run blocks 201-204 to train the neural network 104.

In block 205, object image data may be received by, for example, the serial object image input device 106. The object image data may be the image data to be searched for the target object. The serial object image input device 106 in block 205 may function similarly to the serial target image input device 100 in block 201. However, each item of object image data may not be tagged or otherwise linked to identification information indicating whether or not the item of image data contains the target object, as the object image data will be searched for the target object. Additionally, the object image data may be in the form of a live video feed.

In block 206, the object image data may be decoded and/or decompressed by, for example, the codex 107. The codex 107 may receive the object image data from the serial object image input device 106. The codex 107 in block 206 may function similarly to the codex 101 in block 202, creating object image files instead of target image files. The object image files created by the codex 107 may be transferred to the object image file storage device 108, which may function similarly to the target image file storage device 102, to be stored. Block 206 may run until all of the image data received in block 205 has passed through the codex 107, or may only run until some lesser amount of the image data has passed through the codex 107, depending on the constraints of the system and designer preference. Flow may also proceed back to block 205, depending on designer preference.

In block 207, the object image files may undergo image feature extraction performed by, for example, the object image feature extraction device 109. The object image files created by the codex 107 may be transferred from the object image file storage device 108 to the object image feature extraction device 109. The object image feature extraction device 109 may perform the process of object image feature extraction using non-negative matrix factorization (NMF) on an object image file to create a object extracted image feature file. In block 207, applying NMF to the object image file may by similar to block 203. Applying NMF to an object image file in this manner may result in an object extracted image feature file, which may be a sparse representation of the object image file. The object extracted image feature file may be stored as a separate file, and may be sized, cropped, normalized, weighted, or otherwise manipulated as necessary.

The object extracted image feature files may contain links back to the original item of image data, for example, the still image or frame of a video, from which they were created. The object extracted image feature files may also include information regarding the quality, data, time or other text, and other attributes or any searchable data, etc., that may be associated with item of image data from which they were created.

Block 207 may run until all of the object image files received from the codex 107 have been processed with NMF, or may only run until some lesser number of the target image files have been processed with NMF, depending on the constraints of the system and designer preference. Flow may also proceed back to block 205 or 206, again depending on designer preference.

In block 208, the object extracted image feature files may be stored, for example, in the index file storage 110. Block 209 may optionally be run at this time. In block 209, additional information, such as, for example features identified in metadata, the quality of the image in the object image file, and other filterable and searchable data may be stored along with the object extracted image feature files in index file storage 110. If the object extracted image feature files contain common image features that may be searched for as target objects at a future time, for example, in searches intended to perform face recognition, car recognition, or other product recognition, the object extracted image feature files may be processed once to create an index file for that common image feature. For example, if the object extracted image feature files stored in index file storage device 110 all contain the image feature of one or more cars, the group of object extracted image feature files may be stored as an index file for cars. A future search using a car as the target object may then utilize the index file for cars from the index file storage device 110 for object extracted image feature files, rather than repeating blocks 205 through 207.

In block 210, object extracted image feature files from, for example, the index file storage 110 may be input to, for example, the neural network 104, which may produce an answer as to whether or not each object extracted image feature file contains the target object. The neural network 104 may produce an answer of any suitable data type, such as, for example, a yes or no (i.e. 1 or 0) answer, or a probabilistic answer (i.e., 85% match of the target object).

In block 211, the weightings of, for example, the neural network 104 may be adjusted to fine-tune the neural network 104 to the target object. For example, once the neural network 104 has been trained to locate the target object of Kurt Douglas's face, it may be possible to view the weightings of the trained neural network 104 and determine either manually by a user, or automatically, which nodes and weightings in the neural network 104 correspond to specific features of Kurt Douglas's face, for example, Kurt Douglas's nose. Once this determination has been made, manual or automatic adjustments may be made to the weightings of the neural network 104, for example, to make the neural network 104 more accurate in its determination of whether or not a given nose in an image is Kurt Douglas's nose. This may be possible because of the sparseness of the representation of the image data, in the extracted image feature files, created by the use of NMF.

Block 210 may run until all of the object extracted image feature files from the index file storage 110 have been input into the neural network 104, or may only run until some lesser amount of the object extracted image feature files have passed through the neural network 104, depending on the constraints of the system and designer preference.

The neural network 104 may produce more accurate results than a similar neural network trained to identify the presence of the target object using target image data and object image data that was not subject to NMF with enforced sparseness. This may be because the sparseness of the target extracted image feature files and object extracted image feature files may allow the neural network 104 to learn to identify the significant features of the target object more accurately.

In block 212, the answers, or results, produced by, for example, the neural network 104 for each of the object extracted image feature files may be processed. The answers may be linked to the object extracted image feature files for which they were produced and stored as results in the results storage 111. A weighting, or threshold, may be applied to the results. For example, if the neural network 104 returns probabilistic results, a threshold of 70% may be set, such that an item of image whose object extracted image feature file resulting in the neural network 104 providing an answer of 70% or higher would be considered to contain the target object, while items of image data below the threshold would not be considered to contain the target object. Such a weighting or threshold may be used to control the number of items of image data displayed in block 213. Further analysis may be performed on the answers to gauge the probability that results are accurate.

In block 213, the results from may be displayed. For example, the results from the results storage 111 may be displayed on the display device 112. The results may be displayed in any suitable manner, which may be, for example, adjustable by the user viewing the results on the display device 112. For example, the display device 112 may display a listing of the names of image or video files used to create object extracted image feature files that the neural network 104 determined were a 100% match for the target object. Or, thumbnails of the image or video files, or of the objected extracted image feature files, may be displayed. The type of data used to determine which results to display may be dependent on the data type used for the answers given by the neural network 104. For example, if the answers are probabilistic, a probability threshold may be set at any level. The results may be sorted based on the answers, for example, with image or video files with a high probability of a match to the target object displayed first, and those with low probability displayed last, or any other suitable sorting criteria. An interface to the display device 112 may allow a user of the system to select an image or video file from the display of the results in order to view or otherwise manipulate the image or video file.

The group of blocks 201-204 and group of blocks 205-209 may be run sequentially, concurrently, or in an alternating manner, depending on system constraints and designer preference. For example, in one exemplary embodiment one computer may be used to run blocks 201-204, and a second computer may be used to run blocks 205-209 concurrently. Blocks 205-209 may also be run in advance of any of the other blocks. For example, a web crawler may constantly be finding image data, which may be sent the serial object image input device 106 and processed through blocks 205-209, even if no other blocks are run at the time. In this way, object image data may be archived in the index file storage 110 for future use. Further, flow may proceed to block 210 while blocks 205-209 are still running, so long as either blocks 201-204 have been completed, or the neural network 104 is configured based on data in the category storage 105.

In an alternative embodiment, image analysis to determine whether an item of image data is suitable for the application of NMF may be performed in one or more of blocks 201-203, and 205-207. Image quality can be automatically evaluated in order to verify that the image will be useful in searching for the target object. If the quality of an item of image data is too poor for the item of image data to be used, for example, because of low resolution or excessive noise, a new item image data may be obtained automatically, or feedback may be presented to a user on display device 112 instructing the user to locate an item of image data of higher quality.

In another alternative embodiment, the codexes 101 and 107, and the blocks 202 and 206, may be omitted. In such an alternative embodiment, the target image feature extraction device 103 and object image feature extraction device 109 may process the items of image data directly, even if the image data is in a compressed form.

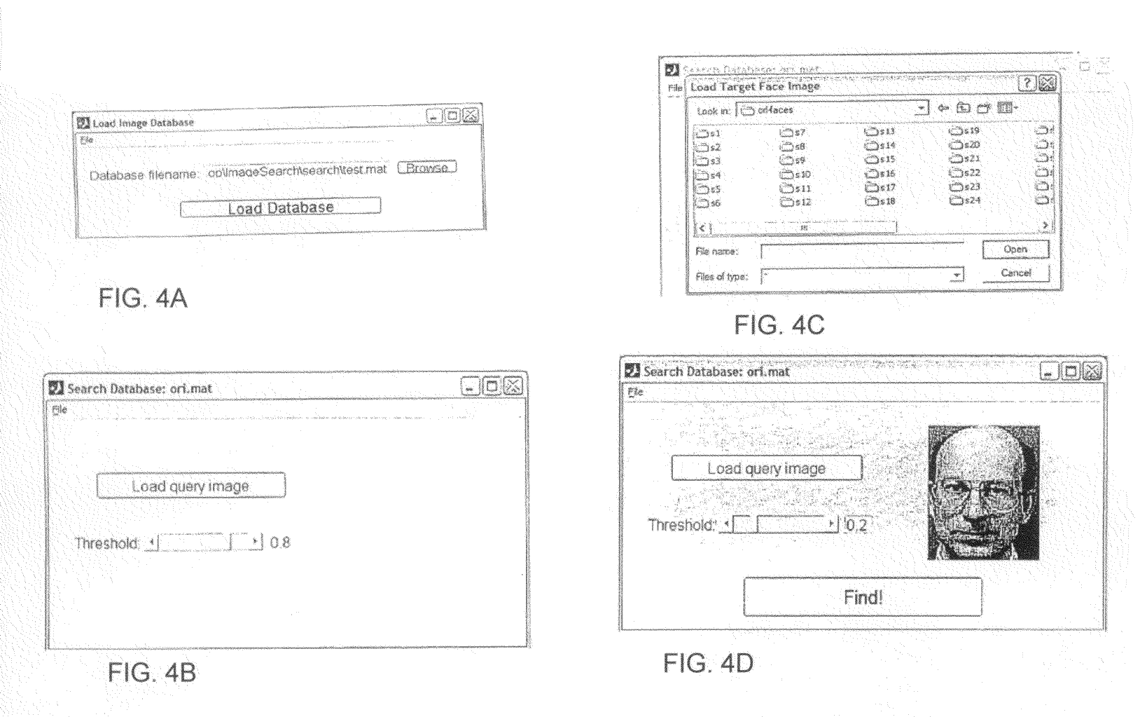

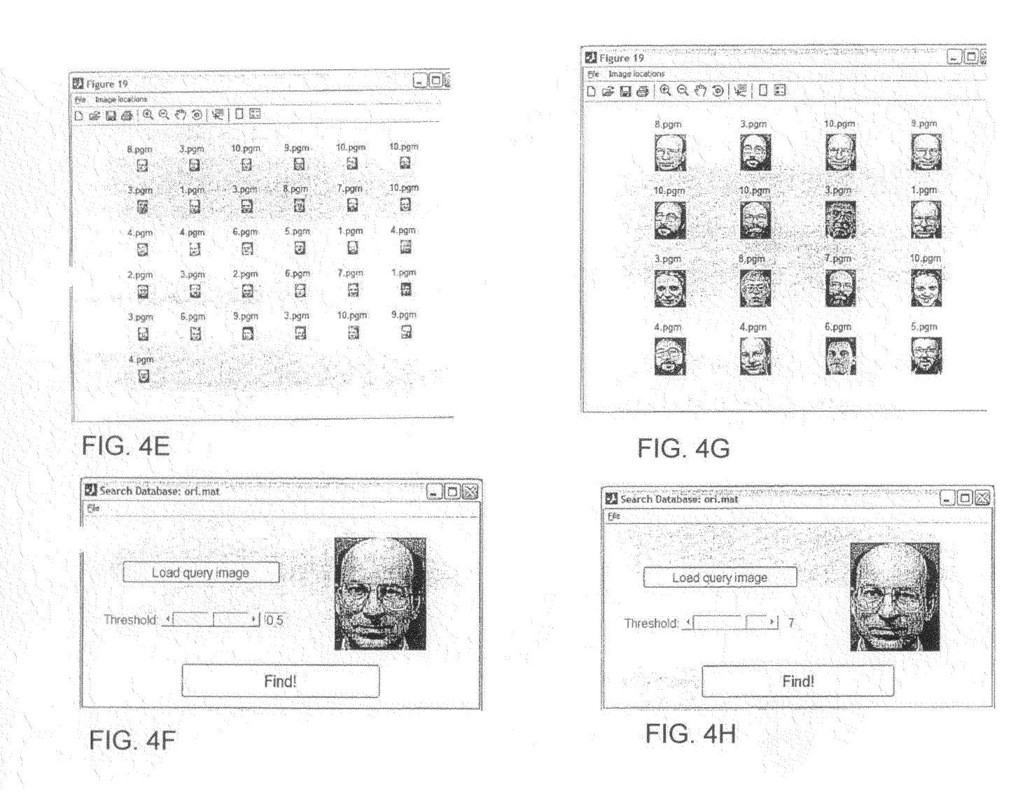

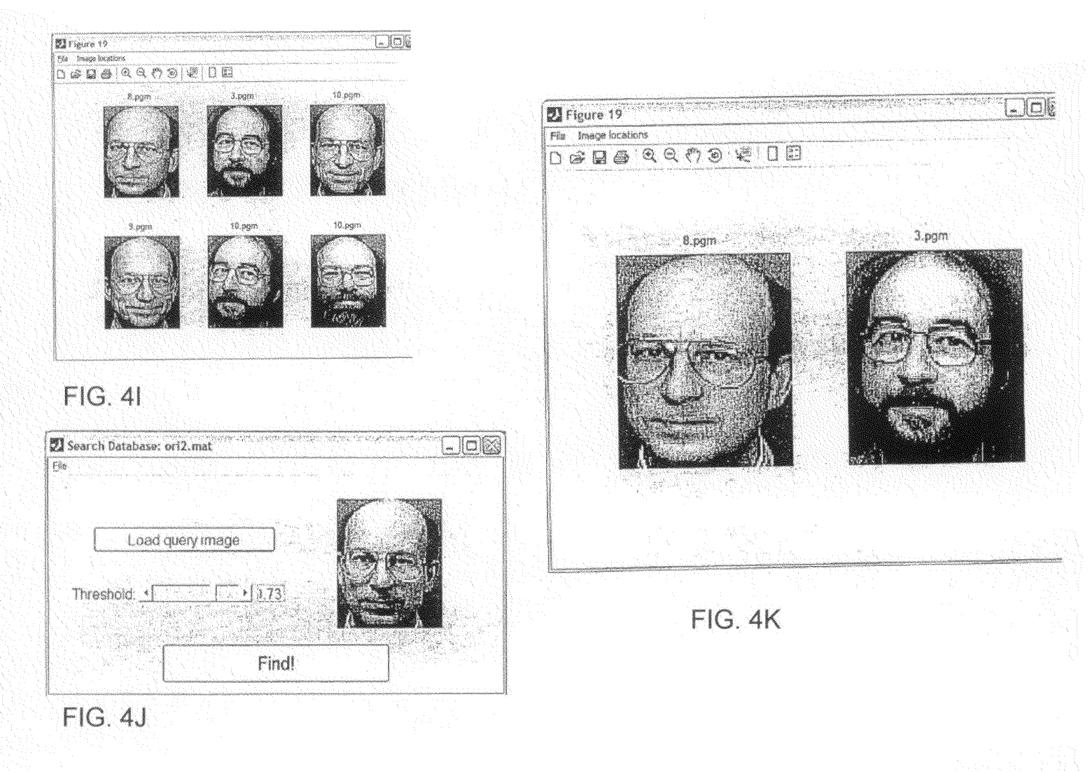

FIGS. 4A-4K depict exemplary screenshots for a system for an automated image and object recognition system. FIGS. 4A-4K are discussed in relation to FIGS. 1 and 2. In FIG. 4A, a database may be selected through a user interface. The database selected in FIG. 4A may be a database of image data, which may serve as the object image data to be transferred to the serial object image input device 106. Alternatively, the database in FIG. 4A may be index file selected from the index file storage 110.

In FIGS. 4B and 4C, an item of image data containing the target object may be selected through a user interface. A threshold may be set, which may be used, for example, in block 207 when analyzing the results, or, for example, in block 213, when displaying the results on the display device 112. The threshold in FIG. 4B is set at 0.8, which may indicate that only items of object image data determined by the neural network 104 to have an at least 80% probability of containing a match for the target object will be displayed as results. The item of image data may be selected from a folder, e.g., “13”. The selected item of image data may be sent to the serial target image input device 100.

In FIG. 4D, an item of image data containing the target object, in this example, a man's face, has been selected, and the selected item of image data may be displayed through the interface. The threshold may also be changed in FIG. 4D. For example, it may be reduced from 0.8, as in FIG. 4B, to 0.2, as in FIG. 4D. A user may use the interface to choose to begin searching for the target object in the object image data or index file selected in FIG. 4A.

In FIG. 4E, the results produced by the neural network 104 may be displayed to the user, as in block 213. The neural network 104 may have determined the probability that each item of object image data from the database selected in FIG. 4A contained the target object selected in FIGS. 4B and 4C. If the probability for an item of object image data was higher than the threshold set in FIG. 4B or 4D, for example, 0.2, or 20% probability, as in FIG. 4D, the item of object image data may be displayed to the user in FIG. 4E. Thus, each item of object image data displayed in FIG. 4E was determined by the neural network 104 to have an at least 20% probability of containing a match for the target object.

In FIG. 4F, the user interface may be used to raise the threshold previously set in FIG. 4D, for example, from 0.2 to 0.5. In FIG. 4G, the higher threshold results in fewer items of object image data being displayed as the results produced by the neural network 104, as fewer items of object image data have a probability of containing the target object higher than the new threshold of 0.5, or 50%, set in FIG. 4F.

In FIG. 4H, the threshold may be raised further, from 0.5 to 0.7. This may result in even fewer results being displayed in FIG. 1, as only those items of image data determined by the neural network 104 to have at least a 70% probability of containing a match for the target object are displayed.

In FIG. 4J, the threshold is further raised to 0.73. This may result in just one result being displayed in FIG. 4K. The one item of object image data displayed in FIG. 4K may be the only item of object image data which the neural network 104 determined had at least a 73% chance of containing a match for the target object.

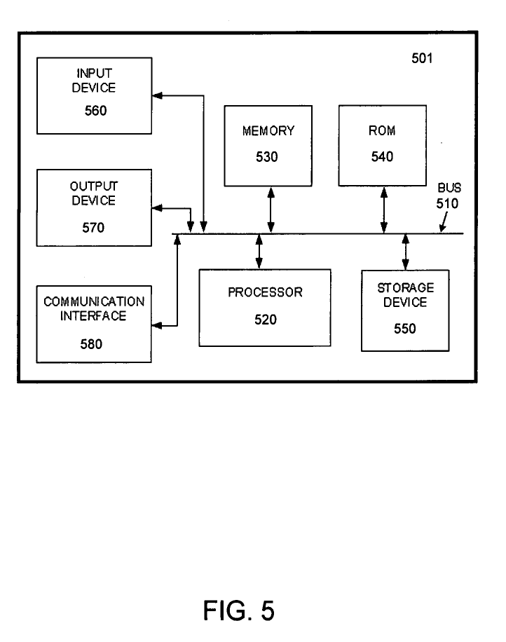

FIG. 5 depicts an exemplary architecture for implementing a computing device 501, which may be used to implement any computer or computer system for use in the exemplary embodiment as depicted in FIG. 1. It will be appreciated that other devices that can be used with the computing device 501, such as a client or a server, may be similarly configured. As illustrated in FIG. 5, computing device 501 may include a bus 510, a processor 520, a memory 530, a read only memory (ROM) 540, a storage device 550, an input device 560, an output device 570, and a communication interface 580.

Bus 510 may include one or more interconnects that permit communication among the components of computing device 501. Processor 520 may include any type of processor, microprocessor, or processing logic that may interpret and execute instructions (e.g., a field programmable gate array (FPGA)). Processor 520 may include a single device (e.g., a single core) and/or a group of devices (e.g., multi-core). Memory 530 may include a random access memory (RAM) or another type of dynamic storage device that may store information and instructions for execution by processor 520. Memory 530 may also be used to store temporary variables or other intermediate information during execution of instructions by processor 520.

ROM 540 may include a ROM device and/or another type of static storage device that may store static information and instructions for processor 520. Storage device 550 may include a magnetic disk and/or optical disk and its corresponding drive for storing information and/or instructions. Storage device 550 may include a single storage device or multiple storage devices, such as multiple storage devices operating in parallel. Moreover, storage device 550 may reside locally on the computing device 501 and/or may be remote with respect to a server and connected thereto via network and/or another type of connection, such as a dedicated link or channel.

Input device 560 may include any mechanism or combination of mechanisms that permit an operator to input information to computing device 501, such as a keyboard, a mouse, a touch sensitive display device, a microphone, a pen-based pointing device, and/or a biometric input device, such as a voice recognition device and/or a finger print scanning device. Output device 570 may include any mechanism or combination of mechanisms that outputs information to the operator, including a display, a printer, a speaker, etc.

Communication interface 580 may include any transceiver-like mechanism that enables computing device 501 to communicate with other devices and/or systems, such as a client, a server, a license manager, a vendor, etc. For example, communication interface 580 may include one or more interfaces, such as a first interface coupled to a network and/or a second interface coupled to a license manager. Alternatively, communication interface 580 may include other mechanisms (e.g., a wireless interface) for communicating via a network, such as a wireless network. In one implementation, communication interface 580 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 501 may perform certain functions in response to processor 520 executing software instructions contained in a computer-readable medium, such as memory 530. In alternative embodiments, hardwired circuitry may be used in place of or in combination with software instructions to implement features consistent with principles of the invention. Thus, implementations consistent with principles of the invention are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device, a stand-alone hardware device, or a number of connected hardware devices.

One embodiment may be used to search one or more websites on the Internet for image files using a webcrawler to obtain object image data. For example, the target object may be a person's face, a cartoon character, a movie still of a particular movie scene, etc. A webcrawler or similar robot may be in a constant process of collecting object image data by crawling across website on the Internet and sending the object image data to a computer or computer system. The computer or computer or computer system may include the neural network 104 already trained to identify the presence of the target object. The computer or computer system may perform blocks 205-213 using the object image data received from the webcrawler. Because the webcrawler may continually send back object image data to the computer or computer system, the computer or computer system may continually perform blocks 210-213. This may be used, for example, to continually search for the use of copyrighted images or videos on websites on the Internet, by selecting the target object to be a copyrighted image or video, such as, for example, a copyrighted cartoon character.

As another example, a webcrawler may be used to assist in user initiated image searches of the Internet. The object image data sent back to the computer or computer system may be processed with blocks 205-208, resulting in index files for the object image data from the Internet being stored in index file storage 110. The number of index files stored in index file storage 110 may continually increase as the webcrawler sends more object image data to be processed. A user may then use the user's computer to visit a website on the Internet where the user may upload, or provide links to, items of image data containing a target object the user wishes to search for on the Internet. Blocks 201-204 may be performed on the items of image data provided by the user, and then the trained neural network 104 may be used to search for the target object using the index files stored in index file storage 110.

One embodiment may use a predefined archive of object image data. For example, a movie studio may want to be able to search through the movie studio's own movies. The predefined archive of object image data may then be the movie studio's movies, which may be processed through blocks 205-209 to produce an index file to store in the index file storage 110. Searches may then be performed on the movie studio's movies by having the neural network 104, once trained to identify the presence of the target object, use only the index file for the movie studio's movies from the index file storage 110.

One embodiment may be a hardware device capable of performing all of the blocks shown in FIG. 2, which may be connected to an existing computer or computer system. For example, the hardware device may be designed to be connected to a server farm by plugging into a server rack. The hardware device may be able to perform all of the block shown in FIG. 2 without assistance from any other hardware and/or software, or the hardware device may utilize hardware and/or software available on the computer or computer system to which the hardware device is connected, including, for example, computer-readable mediums, processors, and communications devices. For example, to implement the image file storage devices 102 and 108, the index file storage 110, the category storage 105, and the results storage 108, the hardware device connected to a server farm may include a permanent computer-readable medium, or may use a permanent computer-readable medium on one or more of the server's in the server form.

Exemplary embodiments may use Web 2.0 implementations, including analytic and database server software back-ends, Really Simple Syndication (RSS) type content-syndication, messaging-protocols such as, for example, Simple Object Access Protocol (SOAP), standards-based browsers with AJAX Asynchronous JavaScript and XML (AJAX) and/or Flex support.

Web 2.0 web services may support the SOAP web services stack and XML data over HTTP, which may be referred to as REST (Representational State Transfer). Exemplary embodiments may use the AJAX interface, which may allow re-mapping data into new services. Exemplary embodiments may also include seamless information flow from a handheld device to a massive web back-end, with the PC acting as a local cache and control station. The AJAX interface may provide standards-based presentations using XHTML and CSS, dynamic display/interactions using the Document Object Model (DOM), data inter-changes/manipulations using XML/XSLT, asynchronous data retrieval using the XMLHttpRequest protocol and Java/JavaScript for development. Rapid importation of files from Flash and multimedia players running natively may be supported without requiring a pixel by pixel importation.

While various exemplary embodiments have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A computer-readable medium comprising instructions, which when executed by a computer system causes the computer system to perform operations for target object recognition in images and video comprising:
instructions for receiving an item of target image data, wherein the item of target image data includes a target object;
instructions for applying non-negative matrix factorization with enforced sparseness to the item of target image data to generate an item of target extracted image feature data;
instructions for training a neural network to identify the target object using the item of target extracted image feature data to obtain a trained neural network;
instructions for receiving an item of object image data;
instructions for applying non-negative matrix factorization with enforced sparseness to the item of object image data to generate an item of object extracted image feature data;
instructions for analyzing the item of object extracted image feature data with the trained neural network to obtain a result indicating whether the presence of the target object is identified in the item of object image data; and
instructions for storing the result of analyzing the item of object extracted image feature data.

2. The computer-readable medium of claim 1, further comprising instructions for processing the item of target image data with a codex before applying non-negative matrix factorization to the item of target image data.

3. The computer-readable medium of claim 1, further comprising instructions for processing an item of object image data with a codex before applying non-negative matrix factorization to the at least on item of object image data.

4. The computer-readable medium of claim 1, wherein the item of object image data is received from a webcrawler.

5. The computer-readable medium of claim 1, wherein the item of target image data is received via the Internet.

6. The computer-readable medium of claim 1, further comprising instructions for adjusting the trained neural network based on a correspondence between a node or weight in the trained neural network and a feature of the target object.

7. The computer-readable medium of claim 1, wherein the instructions for applying non-negative matrix factorization with enforced sparseness comprise:
instructions for performing factorization of a n×m matrix V including an item of object image data or an item of target image data into non-negative matrices W and H, according to the iterative equations:
$${W}_{ia} ← {W}_{ia} {\sum }_{μ} \frac{{V}_{i μ}}{{( WH )}_{i μ}} {H}_{a μ}$$
$${W}_{ia} ← \frac{{W}_{ia}}{{\sum }_{j} {W}_{ja}}$$
$${H}_{a μ} ← {H}_{a μ} {\sum }_{j} {W}_{ia} \frac{{V}_{i μ}}{( WH ) i μ}$$
wherein W is an i×α matrix, H is an α×μ matrix, j is an iterator, and sparseness may be constrained at the end of every iteration according to the equations:
sparseness(wᵢ)=S_{w},∀i
sparseness(hᵢ)=Sₕ,‡i
wherein wᵢ is the i th column of, hᵢ is the i th column of H, and S_{w} and Sₕ are the desired sparseness of W and H.

8. The computer-readable medium of claim 7, wherein sparseness is measured using the equation:
$$sparseness ( x ) = \frac{\sqrt{n} - ( \sum \vert {x}_{i} \vert ) / \sqrt{\sum {x}_{i}^{2}}}{\sqrt{n} - 1}$$
wherein n is the dimensionality of x.

9. The computer-readable medium of claim 1, wherein the target object is copyrighted.

10. A computer-implemented method for automated image and object recognition comprising
receiving an item of target extracted image feature data generated by applying non-negative matrix factorization with enforced sparseness to an item of object image data, wherein the item of target extracted image feature data includes a target object;
training a neural network to identify the target object using the item of target extracted image feature data to obtain a trained neural network;
receiving an item of object extracted image feature data generated by applying non-negative matrix factorization with enforced sparseness to an item of object image data;
analyzing the item of object extracted image feature data with the trained neural network to obtain a result indicating whether the presence of the target object is identified in the item of object image data; and
storing the result of analyzing the item of object extracted image feature data.

11. The computer-implemented method of claim 10, further comprising adjusting the trained neural network based on a correspondence between a one node or weight in the trained neural network and a feature of the target object.

12. The computer-implemented method of claim 10, wherein applying non-negative matrix factorization with enforced sparseness comprises:
performing factorization of a n×m matrix V including an item of object image data or an item of target image data into non-negative matrices W and H, according to the iterative equations:
$${W}_{ia} ← {W}_{ia} {\sum }_{μ} \frac{{V}_{i μ}}{{( WH )}_{i μ}} {H}_{a μ}$$
$${W}_{ia} ← \frac{{W}_{ia}}{{\sum }_{j} {W}_{ja}}$$
$${H}_{a μ} ← {H}_{a μ} {\sum }_{j} {W}_{ia} \frac{{V}_{i μ}}{( WH ) i μ}$$
wherein W is an i×α matrix, H is an α×μ matrix, j is an iterator, and sparseness may be constrained at the end of every iteration according to the equations:
sparseness(wᵢ)=S_{w},∀i
sparseness(hᵢ)=Sₕ,‡i
wherein wᵢ is the i th column of, hᵢ is the i th column of H, and S_{w} and Sₕ are the desired sparseness of W and H.

13. The computer-implemented method of claim 12, wherein sparseness is measured using the equation:
$$sparseness ( x ) = \frac{\sqrt{n} - ( \sum \vert {x}_{i} \vert ) / \sqrt{\sum {x}_{i}^{2}}}{\sqrt{n} - 1}$$
wherein n is the dimensionality of x.

14. An apparatus for automated image and object recognition comprising
means for receiving an item of target image data, wherein the item of target image data includes a target object;
means for applying non-negative matrix factorization with enforced sparseness to the item of target image data to generate an item of target extracted image feature data;
means for training a neural network to identify the target object using the target extracted image feature data to obtain a trained neural network;
means for receiving an item of object extracted image feature data generated by means for applying non-negative matrix factorization with enforced sparseness to an item of object image data;
means for analyzing the item of object extracted image feature data with the trained neural network to obtain a result indicating whether the presence of the target object is identified in the item of object image data; and
means for storing the result of analyzing the item of object extracted image feature data.

15. The apparatus of claim 14, further comprising means for adjusting the trained neural network based on a correspondence between a one node or weight in the trained neural network and a feature of the target object.

16. The apparatus of claim 14, wherein mean for applying non-negative matrix factorization with enforced sparseness comprises:
means for performing factorization of a n×m matrix V including an item of object image data or an item of target image data into non-negative matrices Wand H, according to the iterative equations:
$${W}_{ia} ← {W}_{ia} {\sum }_{μ} \frac{{V}_{i μ}}{{( WH )}_{i μ}} {H}_{a μ}$$
$${W}_{ia} ← \frac{{W}_{ia}}{{\sum }_{j} {W}_{ja}}$$
$${H}_{a μ} ← {H}_{a μ} {\sum }_{j} {W}_{ia} \frac{{V}_{i μ}}{( WH ) i μ}$$
wherein W is an i×α matrix, H is an α×μ matrix, j is an iterator, and sparseness may be constrained at the end of every iteration according to the equations:
sparseness(wᵢ)=S_{w},∀i
sparseness(hᵢ)=Sₕ,‡i
wherein wᵢ is the i th column of, hᵢ is the i th column of H, and S_{w} and Sₕ are the desired sparseness of W and H.

17. The apparatus of claim 16, wherein sparseness is measured using the equation:
$$sparseness ( x ) = \frac{\sqrt{n} - ( \sum \vert {x}_{i} \vert ) / \sqrt{\sum {x}_{i}^{2}}}{\sqrt{n} - 1}$$
wherein n is the dimensionality of x.

18. A system for automated image and object recognition
a neural network module adapted to receive target extracted image feature data generated by applying non-negative matrix factorization with enforced sparseness to target image data including target extracted image feature data for a target object, be trained to identify the target object with the target extracted image feature data, receive object extracted image feature data generated by applying non-negative matrix factorization with enforced sparseness to object image data, analyze the object extracted image feature data to obtain a result indicating whether the presence of the target object is identified in the object image data, and store the result of analyzing the object extracted image feature data for the presence of the target object in the object image data.

19. The system of claim 18, further comprising:
a serial target image input device adapted to receive the target image data including the target object, and transmit the target image data to a target image feature extraction device;
a serial object image input device adapted to receive the object image data, and transmit the object image data to an object image feature extraction device;
the target image feature extraction device adapted to receive the target image data, generate the target extracted image feature data from the target image data by applying non-negative matrix factorization with enforced sparseness to the target image data, and transmit the object extracted image feature data to the neural network module; and
the object image feature extraction device adapted receive the object image data, generate the object extracted image feature data from the object image data by applying non-negative matrix factorization with enforced sparseness to the object image data, and transmit the object extracted image feature data to the neural network module.

20. The system of claim 19, further comprising an index file storage adapted to receive the object extracted image feature data from the object image feature extraction device, store the object extracted image feature data, and transmit the object extracted image feature data to the neural network module.
